(19) United States
(12) Patent Application Publication
(10) Pub. No.: US 2021/0019809 A1
(43) Pub. Date: Jan. 21, 2021

(54) AUTOMATIC COMPLETION OF ELECTRONIC ORDERS

(71) Applicant: Capital One Services, LLC, McLean, VA (US)

(72) Inventors: Jeremy J. Phillips, Brooklyn, NY (US); John Thomas Buttram, New York, NY (US); Jillian Stein, New York, NY (US)

(73) Assignee: Capital One Services, LLC, McLean, VA (US)

(21) Appl. No.: 16/514,229

(22) Filed: Jul. 17, 2019

(51) Int. Cl. G06Q 30/06; G06F 9/451; G06Q 50/00; G06N 20/00

(52) U.S. Cl. CPC G06Q 30/0635; G06F 9/451; G06N 20/00; G06Q 50/01; G06Q 30/0641

(57) ABSTRACT

In one aspect, the present disclosure relates to a method for improving the efficiency of an electronic ordering systems, the method comprising: determining a user intends to complete an electronic order using one or more heuristics; determining the user has provided sufficient information to complete the order; initializing a countdown timer; in response to the countdown timer expiring, automatically completing the order; and presenting the user with one or more user interface (UI) controls to cancel the order.

### BACKGROUND

Many websites and mobile applications (“apps”) require users to complete a multi-step ordering process when purchasing goods or services. For example, e-commerce websites may require a user to first add the desired items to their shopping cart, then enter in shipping information, then enter in billing and payment information, and finally to review the order before and click a submit bottom. At each step of the ordering process, it is likely that some number of users will unintentionally become stuck. For example, a user on a smartphone or other mobile device may unintentionally fail to complete an order if the device's battery depletes before the user has a chance to review and finalize the order. As another example, a user may unintentionally fail to complete an order if they become distracted during the checkout process and forget to return to the website/app to complete the order.

### SUMMARY

According to one aspect of the present disclosure, a method for improving the efficiency of an electronic ordering system can include: determining a user intends to complete an electronic order using one or more heuristics; determining the user has provided sufficient information to complete the order; initializing a countdown timer; in response to the countdown timer expiring, automatically completing the order; and presenting the user with one or more user interface (UI) controls to cancel the order.

In some embodiments, the method can include, in response to detecting user input, cancelling the countdown timer. In some embodiments, determining a user intends to complete an electronic order using one or more heuristics can include at least one of: determining the user added at least one item to the order; and determining the user filled in at least one field or an order form. In some embodiments, the method can include displaying a UI control representing the countdown timer. In some embodiments, completing the order can include transmitting a payment transaction to a payment processing system, the payment transaction having a type selected to facilitate cancellation. In some embodiments, determining the user has provided sufficient information to complete the order can include retrieving, from a storage device, payment information previously entered by the user. In some embodiments, the order can include an order to replace a payment card. In some embodiments, the order can include an order for a ride-sharing vehicle.

According to another aspect of the present disclosure, a method for improving the reliability of mobile devices can include: determining a user of an app intends to complete an electronic order using one or more heuristics, the app running on a mobile device; determining an estimated time remaining for a battery of the mobile device; in response to determining that the estimated time remaining is less than a predetermined threshold value, automatically completing the order; and presenting the user with one or more user interface (UI) controls to cancel the order.

In some embodiments, determining the user of the app intends to complete an electronic order using one or more heuristics can include at least one of: determining the user added at least one item to the order; and determining the user filled in at least one field or an order form. In some embodiments, the method can include displaying, within the app, a UI control representing the countdown timer. In some embodiments, completing the order can include transmitting a payment transaction to a payment processing system, the payment transaction having a type selected to facilitate cancellation. In some embodiments, the method can include determining the user has provided sufficient information to complete the order. In some embodiments, determining the user has provided sufficient information to complete the order can include retrieving, from a storage device, payment information previously entered by the user. In some embodiments, the order may include an order to replace a payment card. In some embodiments, the order can include an order for a ride-sharing vehicle.

According to another aspect of the present disclosure, an electronic ordering system can include a processor and a non-volatile memory. The non-volatile memory can store instructions that when executed on the processor cause the processor to: determine a user intends to complete an electronic order using one or more heuristics; determine the user has provided sufficient information to complete the order; initialize a countdown timer; in response to the countdown timer expiring, automatically complete the order; and present the user with one or more user interface (UI) controls to cancel the order.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a diagram of a system for electronic ordering, according to some embodiments of the present disclosure.

FIGS. 2A and 2B show examples of graphical user interfaces (GUIs) that may be used within an electronic ordering process, according to some embodiments of the present disclosure.

FIG. 3 is a flow diagram showing processing that may occur within the system of FIG. 1, according to some embodiments of the present disclosure.

FIG. 4 is a flow diagram showing processing that may occur within the system of FIG. 1, according to some embodiments of the present disclosure.

FIG. 5 is a block diagram of a user device, according to some embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Described herein are embodiments of a system and method for automatically completing electronic orders for a user. In some embodiments, software running on a user's device and/or on a server device can determine that a user intends to complete an order using one or more heuristics. After determining that the user intends to complete an order, a countdown timer may be started for the current step of the ordering process. If the user does not complete that step of the ordering process before the timer expires, the software can automatically complete the order on behalf of the user. In some embodiments, the user is given one or more controls for easily canceling an order that has been automatically completed for them. The present disclosure can improve the efficiency of electronic ordering systems by reducing the number of abandoned orders, and the average time it takes users to complete the ordering process relative to existing electronic order systems.

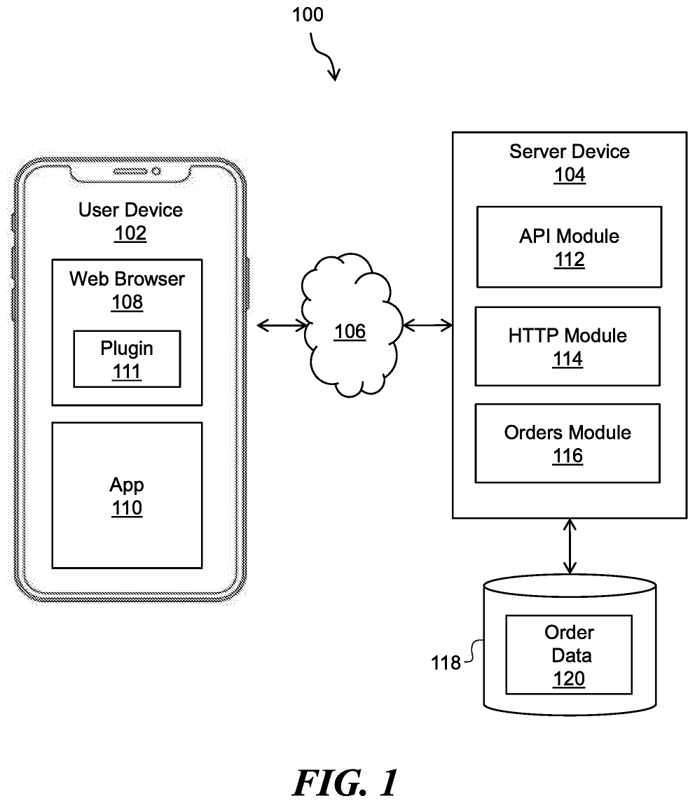

FIG. 1 shows a system for electronic ordering, according to some embodiments of the present disclosure. An illustrative system 100 can include one or more user devices 102 communicatively coupled to a server device 104 via a network 106. To promote clarity in the drawings, only one user device 102 is shown in FIG. 1, however, a skilled artisan will understand that the system described herein can support an arbitrary number of user devices 102 communicating with one or more server devices 104.

The illustrative server device 104 can include an Application Programming Interface (API) module 112, a Hypertext Transfer Protocol (HTTP) module 114, and an orders module 116. Each of the modules 112, 114, 116 can include hardware and/or software configured to perform the processing described herein. Server device 104 can include or otherwise access a database 118. Database 118 can be configured to store, for example, order data 120 for a plurality of users.

API module 112 can provide one or more interfaces by which apps running on user devices 102 can send data requests and receive responses. HTTP module 114 can receive HTTP requests from, and send HTTP responses to, web browsers running on user devices 102. In some embodiments, API module 112 can send and receive data in a JavaScript Object Notation (JSON) format. In some embodiments, HTTP module 114 may provide a RESTful interface accessible by web apps running on user devices 102. A skilled artisan will understand that other data formats can be used to interface user devices 102 with server devices 104.

Orders module 116 may be configured to manage order data 120 stored within database 118. For example, orders module 116 can create new orders, add and remove items to existing orders, process order payments, and retrieve information about previously completed orders. In some embodiments, API module 112 and/or HTTP module 114 can delegate request processing to orders module 116. For example, when a user adds an item to their electronic shopping cart, the app or web page running on their user device 102 may send a corresponding request to either API module 112 or HTTP module 114, which in turn may delegate the request to orders module 116.

In some embodiments, server device 104 and/or database 118 may be part of a financial computer network. For example, server 104 may be hosted by a financial institution (e.g., CAPITAL ONE™) that provides the disclosed functionality to its customers. However, embodiments are not limited in this manner, e.g., the server 104 may be part of a ride-sharing system, an online store front (e-commerce), an cloud computing provider, and so forth.

User devices 102 can include smartphones, tablet computers, laptop computers, desktop computers, among other types of electronic computing devices. In some embodiments, a user device 102 can include a web browser 108 and one or more apps 110. Web browser 108 and/or app 110 may be configured to automatically complete electronic orders for the user. In some embodiments, a web browser plugin 111 installed on the user device 102 may implement automatic order completion as disclosed herein. In some embodiments, a web page displayed in the web browser 108 may include JavaScript configured to automatically complete orders for the user.

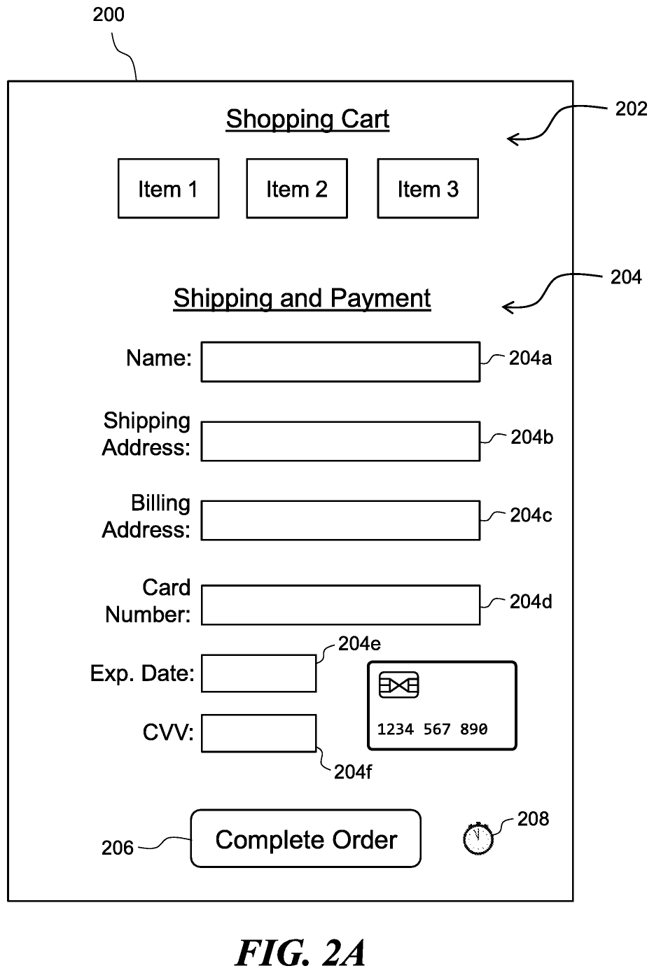

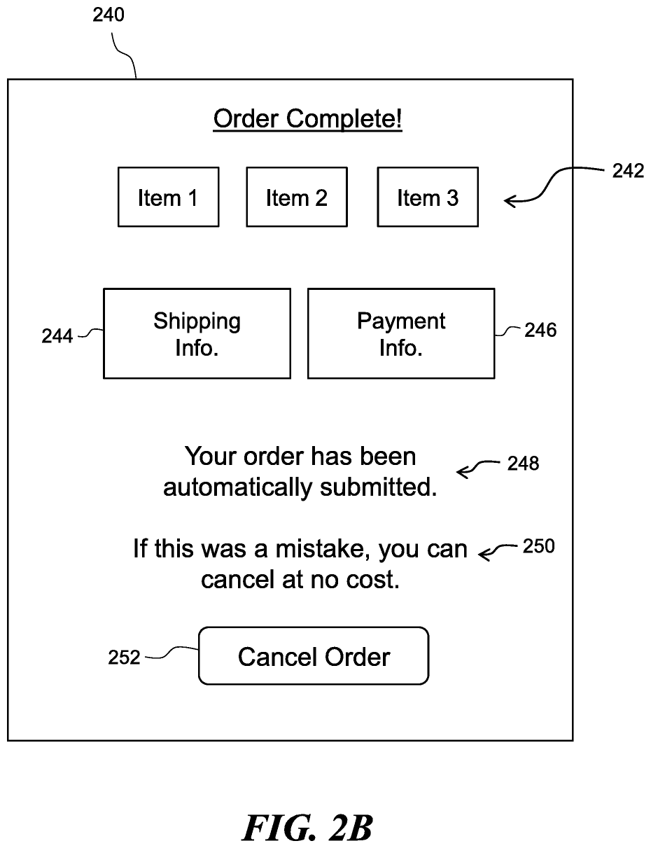

FIGS. 2A and 2B show examples of graphical user interfaces (GUIs) that can be used within an electronic ordering system, such as system 100 of FIG. 1. In some embodiments, the GUIs may correspond to web pages generated by a web server (e.g., server device 104 in FIG. 1) or another server and displayed by a web browser (e.g., web browser 108 of FIG. 1). In some embodiments, the illustrative GUIs may correspond to screens within an app (e.g., app 110 of FIG. 1). The GUIs shown in FIGS. 2A and 2B may form a portion of a multi-step ordering process. In general, the systems and methods disclosed herein can be used to improve the efficiency of an ordering process having an arbitrary number of steps (e.g., two or more steps).

FIG. 2A shows an example of an electronic order form GUI 200, according to some embodiments of the present disclosure. The illustrative GUI 200 can include a shopping cart display 202, a shipping and payment form 204, and a complete order button 206. The shopping cart display 202 can display one or more items (“Item 1”, “Item 2”, etc.) that the user previously added to their cart. The illustrative shipping and payment form 204 can include a name input 204a, shipping address inputs 204b, billing address inputs 204c, and payment card inputs 204d-204f. The form inputs 204a-204f may be provided as a combination of text boxes, radio buttons, checkboxes, drop-down lists, and other types of user input controls.

A user can enter data into the form inputs 204 and then click the complete order button 206. In response, GUI 200 can transmit the user data to a server device (e.g., server device 104 of FIG. 1) where it can be used to complete the order. If the user fails to fill out all of the required form inputs 204 or fails to click complete order button 206, the order may be automatically completed for the user under certain conditions.

In some embodiments, there are three conditions that may be met before a user's order is automatically completed. First, a determination may be made that the user intends to complete the order. This determination can be made based on one or more heuristics. For example, intent may be determined based on whether the user has filled in at least a threshold number of the form inputs 204a-204f (e.g., at least one form input). In some embodiments, the web browser or app running on the user's device may track which form inputs the user has filled out. In some embodiments, after the user completes a particular form input 204, GUI 200 may send the corresponding user data to the server device, and the server device can determine which form inputs—or the number of total inputs—that the user has filled out. As another example, intent to complete the order may be determined once the user has added at least a threshold number of items to their shopping cart (e.g., at least one item). As another example, may be determined when the user visits the order form GUI 200 at least a predetermined number of times (e.g., at least twice). Embodiments are not limited to these examples.

Second, the system must have sufficient information about the user and/or the order before the order can be automatically completed. This condition can be met when the user fills out all of the form fields 204. Alternatively, this condition can be met based on data stored by the system for previous orders from the same user. For example, if the user previously chose to save their billing information with the system during a previous order, then the system may have sufficient information to complete the order when the user fills out the shipping address 204b for the current order. In this case, the name input 204a, billing address 204c, and payment card form inputs 204d-204f fields can be defaulted based on the stored billing information. In some embodiments, the shipping address 204b may be defaulted to the billing address 204c, or vice-versa. In some embodiments, the system may default the shipping address based on the user's current location. In some embodiments, the shipping address 204b may be automatically determined based on items 242 included within the order. For example, if the order includes flowers for Mother's Day, the shipping address 204b may be defaulted to the address of the user's mother, if known. As another example, if the order includes office supplies, the shipping address 204b may be defaulted to the user's office address, if known.

Third, a determination may be made that the user and/or the web browser has become stuck or stalled during the ordering process. In some embodiments, this determination can be based on the amount of time the user “hovers” on a particular step (e.g., remains on the same web page) of the ordering process (e.g., on the step of FIG. 2A). In some embodiments, after it has been determined that (1) the user intended to complete the order and (2) that the system has sufficient information to complete the order, a countdown timer may be initialized. If the user fails to provide additional input or click the complete order button 206 before the timer expires, then the system may automatically complete the order for the user. In some embodiments, the timer may be implemented on the user device. For example, GUI 200 may be implemented as a web page that initializes a countdown timer and, when the timer expires, automatically submits the order form to the server device for automatic completion. In some embodiments, the timer may be implemented on the server device, or on both the user device and the server device.

In some embodiments, the order form GUI 200 may include a countdown timer display 208 that displays an amount of time remaining before the order is automatically completed (e.g., before the form 204 is automatically submitted to the server device). The countdown timer display 208 can provide a visual clue to the user that the form is about to be auto-submitted (e.g., their order is about to be auto-completed). In some embodiments, GUI 200 may include one or more controls (not shown) for the user to explicitly cancel the order.

In some embodiments, the user device may automatically complete the order if it detects that its battery level is low. For example, an app running on the device may periodically determine an estimated time remaining for the device's battery. If the estimated battery time remaining is less than a predetermined threshold (e.g., 1 minute or 5 minutes), the app may automatically submit the order to the server device before the device's battery dies. Here, the order form GUI 200 may display a message such as “If your phone dies, we will auto-complete the order for you” and the countdown timer display 208 may be based on the amount of time estimated remaining on the user device's battery. In some embodiments, the user device or server device may automatically complete an order in response to detecting that the user device has poor network connectivity (e.g., poor cellular or Wi-Fi connectivity).

FIG. 2B shows an example of an electronic order completion GUI 240, according to some embodiments of the present disclosure. The illustrative GUI 240 can display a list of items 242 within the order (“Item 1”, “Item 2”, etc.), the user's shipping information 244, the user's payment/billing information 246, and an order confirmation message display 248. The confirmation message display 248 can indicate that the order was automatically submitted.

In some embodiments, the order completion GUI 240 may include one or more controls to enable the user to easily cancel an auto-submitted order. For example, GUI 240 may include cancellation instructions 250 and a cancel order button 252. In some embodiments, to facilitate cancellation, a special payment card transaction may be used for auto-completed orders. A skilled artisan will understand that there are several different kinds of payment card transactions, including “card not present” transactions and “customer initiated” transactions. A new type of payment card transaction may be used for auto-completed orders that make it easier for customers to cancel an order without facing any penalty.

In some embodiments, the server device may send the user an email, short messages service (SMS) message, or another type of notification when an order is auto-completed. The notification may include controls for canceling the order. In some embodiments, the system may learn each user's preference regarding automatic order completion. For example, if a user cancels more than a threshold number of automatically-completed orders (e.g., more than two such orders), then the system may stop auto-completing orders for that user.

In some embodiments, the systems and methods disclosed herein for automatically completing orders can be used for ordering of financial services items like debit cards, cashier's checks, banking transfers, bill pay, or other services like e-commerce or mobility. For example, if a user opens a mobile banking app on their device and chooses an option to replace their debit card, the app (in coordination with a server device) may cause a new debit card to automatically be delivered to the user's mailing address of record. In some embodiments, the systems and methods disclosed herein can be used by ride-sharing apps to automatically request that a vehicle is sent to the user's current location if the user hovers on the ordering page for a certain amount of time. If a vehicle is automatically sent, a text message may be sent to the user's device with a link for canceling the request.

In some embodiments, the system may automatically place orders based on a user's past behavior using predictive techniques. For example, if a user typically orders a vehicle from a ridesharing service to/from work, the system can automatically order a vehicle based on the current time and the user's current location (e.g., if it is 8:00 AM and the user is at their home location, or if it is 5:00 PM and the user is at their work location). In general, the user's current disposition (e.g., their location, recent movements, gate, etc.) along with the current time can be cross-referenced against their past purchasing behavior to automatically place orders on their behalf.

In some embodiments, a machine learning (ML) model can be used to predict whether to automatically place an order for a user based on their current disposition. The ML model can be trained using information about the user's actual orders, including the user's disposition at the time of ordering. The ML model can subsequently be used generate a score of how likely it is that the user intends or desires to place the same order (or a similar order). In some embodiments, an ML model can be trained using crowdsourced ordering data from many users. In some embodiments, the user can choose to allow various third party apps/services to access and use the ML model. The third party apps/services can use the model to predict when the user intends or desires to place an order and to automatically place the order for the user. In some embodiments, a notification is sent to the user after the order is placed and the user may be presented with controls for easily canceling the order (i.e., to “opt out”). If the user cancels an order, the ML model can be updated to improve its accuracy.

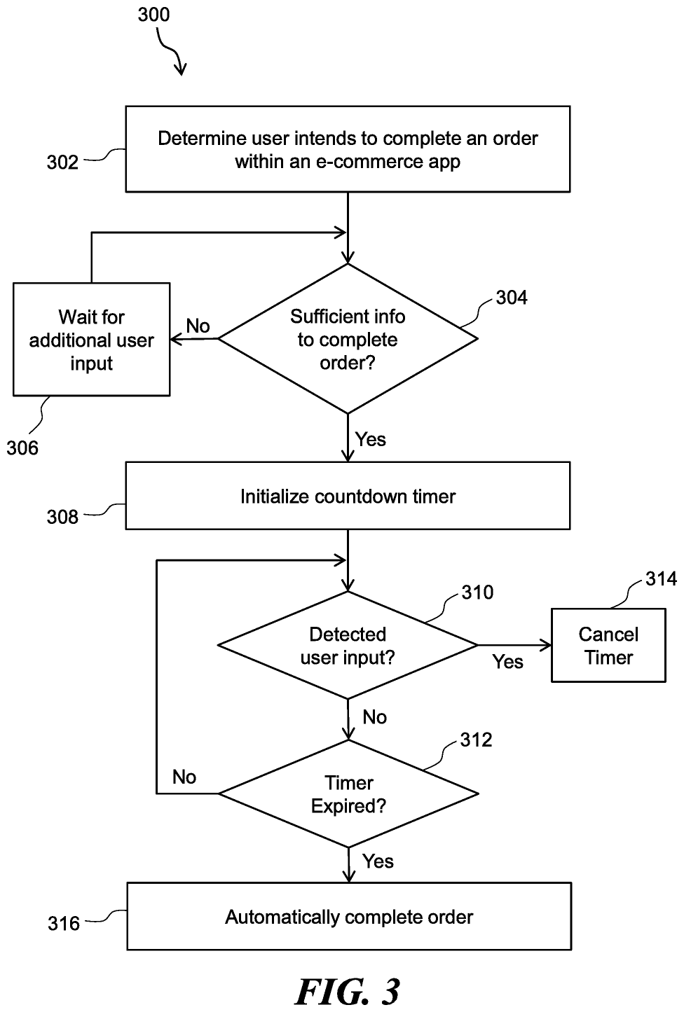

FIG. 3 shows a method for automatically completing electronic orders using a countdown timer, according to some embodiments of the present disclosure. Illustrative method 300 may be implemented within a user device (e.g., user device 102 of FIG. 1), within a server device (e.g., server device 104 of FIG. 1), or partially within a user device and partially within a server device.

At block 302, a determination can be made that the user intends to complete an order. As discussed above in conjunction with FIG. 2A, this determination can be made based on one or more heuristics, such as whether the user has added at least one item to their shopping cart or has filled out at least a portion of an order form.

At block 304, a determination can be made as to whether the system has sufficient information to complete the user's order. As discussed above in conjunction with FIG. 2A, this condition can be met when the user has filled out all required order form fields, or when the system can determine reasonable default values for missing fields. If the system does not have sufficient information to complete the order, then the system may wait for additional input from the user, at block 306. Otherwise, processing may continue to block 308.

At block 308, a countdown timer may be initialized. In some embodiments, the timer may be displayed within a GUI to provide the user with a visual clue as to when the order will be automatically completed.

At block 310, the method can determine if any user input has been received. This can include, for example, detecting whether the user entered data into the order form or navigated to a different page/screen within the app/website. If user input is detected, then the countdown timer may be canceled, at block 314.

At block 312, the method can determine if the countdown timer has expired. If the time has expired, then, at block 316, the order may be automatically completed using one or more the techniques discussed above in conjunction with FIGS. 1, 2A, and 2B. Steps 310 and 312 can be repeatedly performed until either user input is detected or the timer expires. In some embodiments, method 300 can abort if the user explicitly cancels or submits the order.

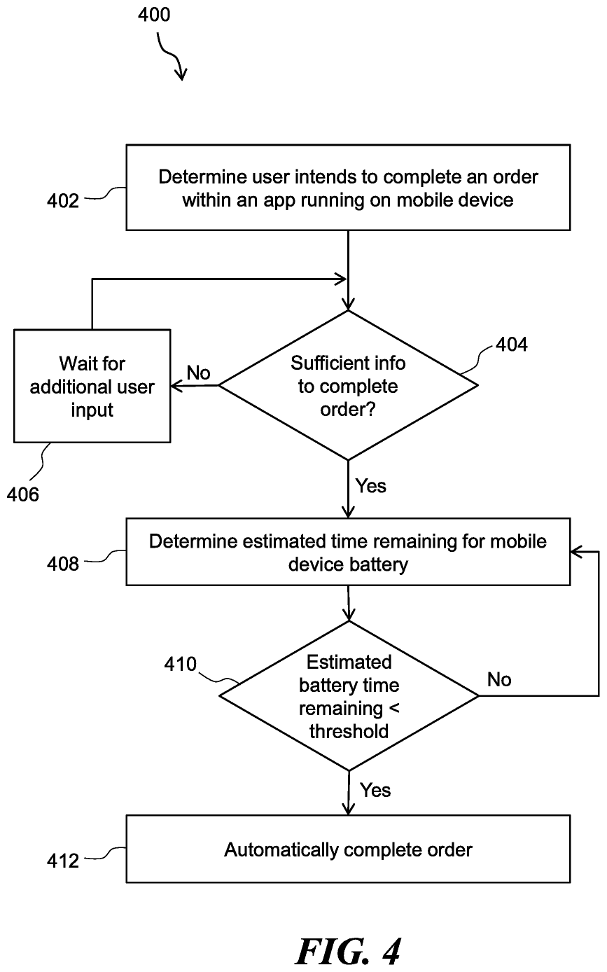

FIG. 4 shows a method for automatically completing electronic orders based on the amount of battery time remaining for a user's device, according to some embodiments of the present disclosure. Illustrative method 400 may be implemented within a user device (e.g., user device 102 of FIG. 1), within a server device (e.g., server device 104 of FIG. 1), or partially within a user device and partially within a server device.

At block 402, a determination can be made that the user intends to complete an order within an app running on a mobile device. As discussed above in conjunction with FIG. 2A, this determination can be made based on one or more heuristics, such as whether the user has added at least one item to their shopping cart or has filled out at least a portion of an order form.

At block 404, a determination can be made as to whether the system has sufficient information to complete the user's order. As discussed above in conjunction with FIG. 2A, this condition can be met when the user has filled out all required order form fields, or when the system can determine reasonable default values for missing fields. If the system does not have sufficient information to complete the order, then the system may wait for additional input from the user, at block 406. Otherwise, processing may continue to block 408.

At block 408, an estimated battery time remaining can be determined for the user device. The estimated battery time remaining may be expressed as an absolute value (e.g., in seconds or minutes), or as a percentage of total battery capacity. A skilled artisan will understand that different device operating systems include different application programming interfaces (APIs) for determining remaining battery time for a device.

At block 410, if the estimated battery time remaining is less than a predetermined battery life threshold (e.g., 1 minute or 5 minutes), then, at block 412, the order may be automatically completed using one or more the techniques discussed above in conjunction with FIGS. 1, 2A, and 2B. Otherwise, the method may repeat from block 408. In some embodiments, method 400 can abort if the user explicitly cancels or submits the order.

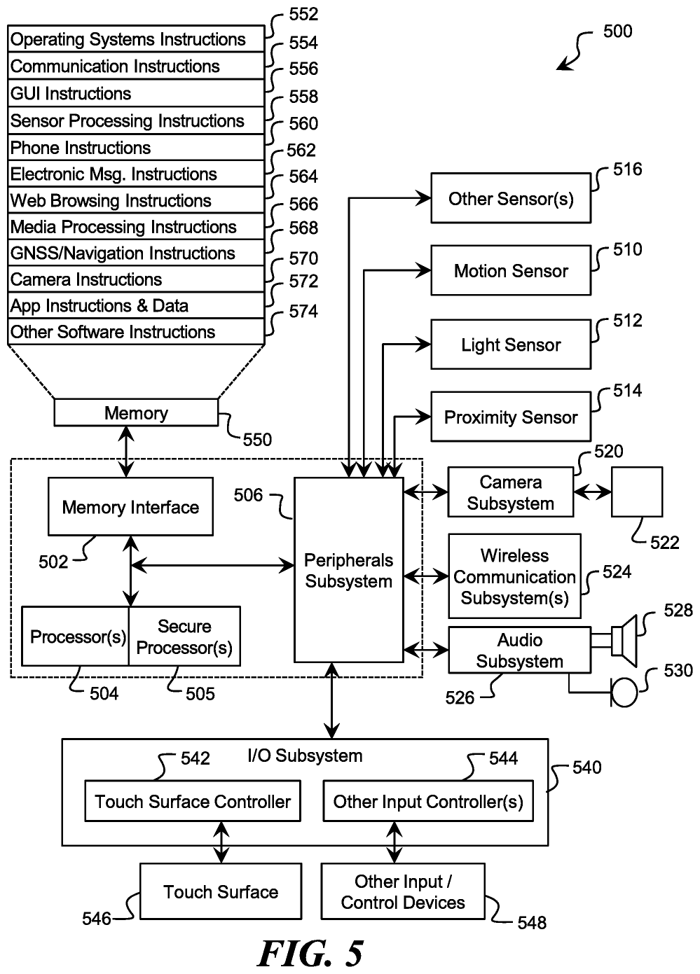

FIG. 5 shows a user device 500, according to an embodiment of the present disclosure. The illustrative user device 500 may include a memory interface 502, one or more data processors, image processors, central processing units 504, and/or secure processing units 505, and a peripherals interface 506. The memory interface 502, the one or more processors 504 and/or secure processors 505, and/or the peripherals interface 506 may be separate components or may be integrated into one or more integrated circuits. The various components in the user device 500 may be coupled by one or more communication buses or signal lines.

Sensors, devices, and subsystems may be coupled to the peripherals interface 506 to facilitate multiple functionalities. For example, a motion sensor 510, a light sensor 512, and a proximity sensor 514 may be coupled to the peripherals interface 506 to facilitate orientation, lighting, and proximity functions. Other sensors 516 may also be connected to the peripherals interface 506, such as a global navigation satellite system (GNSS) (e.g., GPS receiver), a temperature sensor, a biometric sensor, magnetometer, or other sensing device, to facilitate related functionalities.

A camera subsystem 520 and an optical sensor 522, e.g., a charged coupled device (CCD) or a complementary metal-oxide semiconductor (CMOS) optical sensor, may be utilized to facilitate camera functions, such as recording photographs and video clips. The camera subsystem 520 and the optical sensor 522 may be used to collect images of a user to be used during authentication of a user, e.g., by performing facial recognition analysis.

Communication functions may be facilitated through one or more wired and/or wireless communication subsystems 524, which can include radio frequency receivers and transmitters and/or optical (e.g., infrared) receivers and transmitters. For example, the Bluetooth (e.g., Bluetooth low energy (BTLE)) and/or WiFi communications described herein may be handled by wireless communication subsystems 524. The specific design and implementation of the communication subsystems 524 may depend on the communication network(s) over which the user device 500 is intended to operate. For example, the user device 500 may include communication subsystems 524 designed to operate over a GSM network, a GPRS network, an EDGE network, a WiFi or WiMax network, and a Bluetooth™ network. For example, the wireless communication subsystems 524 may include hosting protocols such that the device 500 can be configured as a base station for other wireless devices and/or to provide a WiFi service.

An audio subsystem 526 may be coupled to a speaker 528 and a microphone 530 to facilitate voice-enabled functions, such as speaker recognition, voice replication, digital recording, and telephony functions. The audio subsystem 526 may be configured to facilitate processing voice commands, voice printing, and voice authentication, for example.

The I/O subsystem 540 may include a touch-surface controller 542 and/or other input controller(s) 544. The touch-surface controller 542 may be coupled to a touch surface 546. The touch surface 546 and touch-surface controller 542 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 546.

The other input controller(s) 544 may be coupled to other input/control devices 548, such as one or more buttons, rocker switches, thumb-wheel, infrared port, USB port, and/or a pointer device such as a stylus. The one or more buttons (not shown) may include an up/down button for volume control of the speaker 528 and/or the microphone 530.

In some implementations, a pressing of the button for a first duration may disengage a lock of the touch surface 546; and a pressing of the button for a second duration that is longer than the first duration may turn power to the user device 500 on or off. Pressing the button for a third duration may activate a voice control, or voice command, a module that enables the user to speak commands into the microphone 530 to cause the device to execute the spoken command. The user may customize a functionality of one or more of the buttons. The touch surface 546 can, for example, also be used to implement virtual or soft buttons and/or a keyboard.

In some implementations, the user device 500 may present recorded audio and/or video files, such as MP3, AAC, and MPEG files. In some implementations, the user device 500 may include the functionality of an MP3 player, such as an iPod™. The user device 500 may, therefore, include a 36-pin connector and/or 8-pin connector that is compatible with the iPod. Other input/output and control devices may also be used.

The memory interface 502 may be coupled to memory 550. The memory 550 may include high-speed random access memory and/or non-volatile memory, such as one or more magnetic disk storage devices, one or more optical storage devices, and/or flash memory (e.g., NAND, NOR). The memory 550 may store an operating system 552, such as Darwin, RTXC, LINUX, UNIX, OS X, WINDOWS, or an embedded operating system such as VxWorks.

The operating system 552 may include instructions for handling basic system services and for performing hardware dependent tasks. In some implementations, the operating system 552 may be a kernel (e.g., UNIX kernel). In some implementations, the operating system 552 may include instructions for performing voice authentication.

The memory 550 may also store communication instructions 554 to facilitate communicating with one or more additional devices, one or more computers and/or one or more servers. The memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GNSS/Navigation instructions 568 to facilitate GNSS and navigation-related processes and instructions; and/or camera instructions 570 to facilitate camera-related processes and functions.

The memory 550 may store application instructions and data 572 to implement the functionality discussed above in conjunction with app 110 of FIG. 1. The memory 550 may also store other software instructions 574, such as web video instructions to facilitate web video-related processes and functions; and/or web shopping instructions to facilitate web shopping-related processes and functions. In some implementations, the media processing instructions 566 may be divided into audio processing instructions and video processing instructions to facilitate audio processing-related processes and functions and video processing-related processes and functions, respectively.

Each of the above-identified instructions and applications may correspond to a set of instructions for performing one or more functions described herein. These instructions need not be implemented as separate software programs, procedures, or modules. The memory 550 may include additional instructions or fewer instructions. Furthermore, various functions of the user device 500 may be implemented in hardware and/or in software, including in one or more signal processing and/or application specific integrated circuits.

In some embodiments, processor 504 may perform processing including executing instructions stored in memory 550, and secure processor 505 may perform some processing in a secure environment that may be inaccessible to other components of user device 500. For example, secure processor 505 may include cryptographic algorithms on board, hardware encryption, and physical tamper proofing. Secure processor 505 may be manufactured in secure facilities. Secure processor 505 may encrypt data/challenges from external devices. Secure processor 505 may encrypt entire data packages that may be sent from user device 500 to the network. Secure processor 505 may separate a valid user/external device from a spoofed one, since a hacked or spoofed device may not have the private keys necessary to encrypt/decrypt, hash, or digitally sign data, as described herein.

Methods described herein may represent processing that occurs within an electronic ordering system (e.g., system 100 of FIG. 1). The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, subprograms, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by way of example semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method for improving the efficiency of an electronic ordering systems, the method comprising:
receiving information about past ordering behavior for the user, wherein the past ordering behavior of the user comprises a disposition of the user at a time of ordering;
training a machine learning model to predict whether a user intends to complete an electronic order based at least in part upon the past ordering behavior of the user and the disposition of the user at the time of ordering;
generating a graphical user interface (GUI) for an electronic order checkout, the GUI comprising a plurality of input fields, the plurality of input fields associated with shipping information and payment information for an order;
identifying that the user has partially filled out the plurality of input fields for an electronic order;
determining that the user intends to complete the electronic order by:
monitoring the plurality of input fields in the GUI to determine that the user has filled out at least a threshold amount of input fields of the plurality of input fields,
determining that the user has spent at least a threshold amount of time on the GUI for the electronic order checkout;
determining a current disposition of the user, the current disposition comprising a current time and current location of the user; and
using, the machine learning model, to predict that the user intends to complete the electronic order based on the current disposition of the user;
in response to determining the user intends to complete the electronic order, identifying information associated with the user that can satisfy missing input fields to complete the order;
in response to identifying information associated with the user that can satisfy the missing input fields to complete the order, determining to automatically complete the order based at least in part on preferences stored for the user; and
automatically completing the order using the partially filled out plurality of input fields and the identified information for the missing input fields.

2. The method of claim 29 comprising:
generating a second GUI comprising controls to cancel the order; and
in response to detecting user input with respect to the second GUI, cancelling the countdown timer.

3. The method of claim 1 wherein determining that the user intends to complete the electronic order further comprises:
determining the user added at least one item to the electronic order.

4. (canceled)

5. The method of claim 1 wherein completing the order comprises transmitting a payment transaction to a payment processing system, the payment transaction having a type selected to facilitate cancellation.

6. The method of claim 1 wherein identifying the information associated with the user that can satisfy the missing input fields to complete the order comprises:
retrieving, from a storage device, payment information previously entered by the user.

7. The method of claim 1 wherein the order comprises an order to replace a payment card.

8. The method of claim 1 wherein the order comprises an order for a ride-sharing vehicle.

9-10. (canceled)

11. The method of claim 1 comprising:
receiving crowdsourced ordering data for a plurality of other users,
wherein using ML to predict the user intends to complete the electronic order is further based on the crowdsourced ordering data.

12-19. (canceled)

20. An electronic ordering system comprising:
a processor; and
a non-volatile memory storing instructions that when executed on the processor cause the processor to:
generate a first graphical user interface (GUI) for an electronic order, the first GUI comprising a plurality of input fields, the plurality of input fields associated with billing information for the electronic order;
identify that a user has partially filled out the plurality of input fields for an electronic order;
determine that the user intends to complete the electronic order by:
monitoring the plurality of input fields in the GUI to determine that the user has filled out at least a threshold amount of input fields from the plurality of input fields, and
determining that the user has spent at least a threshold amount of time on the GUI for the electronic order checkout;
identify information associated with the user that can satisfy the missing input fields to complete the order;
initialize a countdown timer; and
automatically complete the order based on the partially filled out plurality of input fields and the identified information that can satisfy the missing input fields.

21. A non-transitory computer readable medium including one or more instructions which, when executed by one or more processors, cause the one or more processors to perform operations for improving the efficiency of an electronic ordering systems, the operations comprising:
generating a graphical user interface (GUI) for an electronic order checkout, the GUI comprising a plurality of input fields, the plurality of input fields associated with billing information for the electronic order;
identifying that a user has partially filled out the plurality of input fields for an electronic order;
determining that the user intends to complete the electronic order by:
monitoring the plurality of input fields in the GUI to determine that the user has filled out at least a threshold amount of input fields of the plurality of input fields, and
determining that the user has spent at least a threshold amount of time on the GUI for the electronic order checkout;
in response to determining the user intends to complete the electronic order, identifying information associated with the user that can satisfy missing input fields to complete the order;
in response to identifying information associated with the user that can satisfy the missing input fields to complete the order, determining to automatically complete the order based at least in part on preferences stored for the user; and
automatically completing the order using the partially filled out plurality of input fields and the identified information for the missing input fields.

22. The non-transitory computer readable medium of claim 30, wherein the operations further comprise:
generating a second GUI comprising controls to cancel the order; and
in response to detecting user input with respect to the second GUI, cancelling the countdown timer.

23. The non-transitory computer readable medium of claim 21, wherein determining that the user intends to complete the electronic order further comprises:
determining the user added at least one item to the order.

24. The non-transitory computer readable medium of claim 21, wherein the operations further comprise:
displaying a UI control representing the countdown timer.

25. The non-transitory computer readable medium of claim 21, wherein completing the order comprises transmitting a payment transaction to a payment processing system, the payment transaction having a type selected to facilitate cancellation.

26. The non-transitory computer readable medium of claim 21, wherein identifying information associated with the user that can satisfy the missing input fields to complete the order comprises:
retrieving, from a storage device, payment information previously entered by the user.

27. The non-transitory computer readable medium of claim 21, wherein determining that the user intends to complete the electronic order further comprises:
receiving information about past ordering behavior for the user;
determining a current disposition for the user; and
using machine learning (ML) to predict the user intends to complete the electronic order based at least in part upon the past ordering behavior for the user and the current disposition for the user.

28. The non-transitory computer readable medium of claim 27, wherein the operations further comprise:
receiving crowdsourced ordering data for a plurality of other users,
wherein using ML to predict the user intends to complete the electronic order is further based on the crowdsourced ordering data.

29. The method of claim 1, further comprising:
in response to determining to automatically complete the order, initializing a countdown timer; and
in response to the countdown timer expiring, automatically completing the order.

30. The non-transitory computer readable medium of claim 27, wherein the operations further comprise:
in response to determining to automatically complete the order, initializing a countdown timer; and
in response to the countdown timer expiring, automatically completing the order.
